(19) United States
(12) Patent Application Publication
(10) Pub. No.: US 2011/0205411 A1
(43) Pub. Date: Aug. 25, 2011

(54) PIXEL ARRAYS, IMAGE SENSORS, IMAGE SENSING SYSTEMS AND DIGITAL IMAGING SYSTEMS HAVING REDUCED LINE NOISE

(76) Inventor: German VORONOV, Holon (IL)

(21) Appl. No.: 12/956,741

(22) Filed: Nov. 30, 2010

Related U.S. Application Data
(60) Provisional application No. 61/282,523, filed on Feb. 25, 2010.

(51) Int. Cl. H04N 5/335

(52) U.S. Cl. 348/294

(57) ABSTRACT

A pixel array for an image sensor includes a plurality of pixels arranged in an array. The plurality of pixels are configured to be read out according to a random pattern such that non-adjacent pixels from a plurality of physical lines in the array are read out concurrently. An imaging system includes at least the pixel array and a descrambling unit. The descrambling unit is configured to descramble pixel information read out from the pixel array.

### CROSS-REFERENCE TO RELATED APPLICATION(S)

This application claims priority under 35 U.S.C. §119(e) to provisional U.S. patent application No. 61/282,523, filed on Feb. 25, 2010, the entire contents of which are incorporated herein by reference.

### BACKGROUND

### Description of the Conventional Art

In a conventional image sensor, all pixels of each line of a pixel array are generally accessed together during pixel array reset and readout. Any noise present in the reset, sampling or control signals is injected into the pixel voltage as a common component of the pixel with the same reset, sampling and readout timing. Usually, this common component appears as a line noise pattern varying from frame-to-frame. There are a number of conventional techniques to reduce this line noise.

An analog approach reduces the root causes of noise that is injected into the pixel signals.

A combination analog and digital approach introduces special pixels having controlled values that do not depend on image content. These special pixels suffer from the same line noise as other pixels with the same timing, and the values of these special pixels are used to estimate the line noise. The estimated line noise is then subtracted from the other pixels in the same line.

These conventional noise reduction techniques are helpful in compensating for the major component of the line noise and may be used in most systems. However, the accuracy of line noise estimation is limited by independent pixel noise. Because special pixels suffer from the pixel noise in a similar way to the other pixels, a relatively large number of special pixels are necessary in order to accurately obtain line noise and filter out pixel noise. But, having a relatively large number of special pixels consumes a relatively significant amount of chip area.

Moreover, residual line noise remains in the image even when using special pixels. The amount of residual line noise is a function of actual line noise and pixel noise in the system as well as the number of special pixels.

### SUMMARY

Example embodiments produce images with less visible residual line noise.

Example embodiments provide pixel arrays, image sensors, image sensing systems and digital imaging systems having reduced line noise.

At least one example embodiment provides a pixel array for an image sensor. The pixel array includes: a plurality of pixels arranged in an array. The plurality of pixels are configured to be read out according to a random pattern such that non-adjacent pixels from a plurality of physical lines of pixels in the array are read out concurrently.

At least one other example embodiment provides an image sensing system. The image sensing system includes a pixel array and a descrambling unit. The pixel array includes: a plurality of pixels arranged in an array. The plurality of pixels are configured to be read out according to a random pattern such that non-adjacent pixels from a plurality of physical lines of pixels in the array are read out concurrently. The descrambling unit is configured to descramble pixel information read out from the pixel array.

At least one other example embodiment provides an image sensing system including: a pixel array; a line driver; and a plurality of timing lines connecting the line driver to the pixel array. The pixel array includes: a plurality of pixels arranged in an array. The plurality of pixels are configured to be read out according to a random pattern such that non-adjacent pixels from a plurality of physical lines of pixels in the array are read out concurrently. The line driver is configured to generate read out signals for reading out pixel information from the pixel array. Each of the plurality of timing lines is connected to at least two non-adjacent pixels, and the at least two non-adjacent pixels are part of at least two non-adjacent physical lines of pixels in the pixel array.

At least one other example embodiment provides a digital imaging system including: a processor configured to process captured image data; and an image sensor configured to capture image data by converting optical images into electrical signals. According to at least this example embodiment, the image sensor includes a pixel array and a descrambling unit. The pixel array includes: a plurality of pixels arranged in an array. The plurality of pixels are configured to be read out according to a random pattern such that non-adjacent pixels from a plurality of physical lines of pixels in the array are read out concurrently. The descrambling unit is configured to descramble pixel information read out from the pixel array.

At least one other example embodiment provides a digital imaging system including: a processor configured to process captured image data; and an image sensor configured to capture image data by converting optical images into electrical signals. According to at least this example embodiment, the image sensor includes: a pixel array; a line driver; and a plurality of timing lines connecting the line driver to the pixel array. The pixel array includes: a plurality of pixels arranged in an array. The plurality of pixels are configured to be read out according to a random pattern such that non-adjacent pixels from a plurality of physical lines of pixels in the array are read out concurrently. The line driver is configured to generate read out signals for reading out pixel information from the pixel array. Each of the plurality of timing lines is connected to at least two non-adjacent pixels, and the at least two non-adjacent pixels are part of at least two non-adjacent physical lines of pixels in the pixel array.

According to at least some example embodiments, at least a portion of the non-adjacent pixels may be from a plurality of non-adjacent physical lines of the array. The plurality of pixels may be divided into blocks of pixels, and each block of pixels may be configured to be read out according to at least a first random sub-pattern. Each first random sub-pattern may be defined by a random number generator.

Each block of pixels may be further divided into a plurality of groups of randomly selected lines of the array, and the pixels in each group may be configured to be read out according to a second random sub-pattern.

Each block of pixels may be configured to be read out according to at least two random sub-patterns.

At least one of the random pattern and the first random sub-pattern may be defined by a linear feedback shift register (LFSR).

According to at least some example embodiments, pixels in the array may be grouped into a plurality of super pixels, and each of the plurality of super pixels may be configured to be read out according to a first random sub-pattern. For each super pixel, pixels of a same color may combined in the analog domain (or binned) at least one of before and during readout. Each of the plurality of super pixels may include a plurality of pixels from a set of adjacent physical lines among the plurality of physical lines.

According to at least some example embodiments, the image sensor may further include: an analog to digital converter configured to convert the pixel information into digital output information, and configured to store the digital output information. A line noise compensation unit may be included to estimate and compensate for line noise present in the digital output information. An image signal processing block may be configured to generate image information based on the compensated digital output information.

According to at least some example embodiments, the descrambling unit may be configured to descramble pixel information read out from the pixel array according to a pattern inverse to the random pattern.

### BRIEF DESCRIPTION OF THE DRAWINGS

Example embodiments will become more apparent and readily appreciated from the following description of the drawings in which:

FIG. 1 illustrates a conventional complementary metal oxide semiconductor (CMOS) image sensor;

FIGS. 2A and 2B are more detailed illustrations of conventional image sensors;

FIG. 3 illustrates a pixel array configured to be readout according to a conventional method;

FIG. 4 illustrates a pixel array configured to be readout according to an example embodiment;

FIG. 5 illustrates an example embodiment of a pixel array configured according to an unconstrained block scrambling method;

FIG. 6 illustrates an example embodiment of a pixel array configured according to a constrained block scrambling method;

FIG. 7 illustrates an example embodiment of a pixel array configured according to a semi-constrained block scrambling method;

FIGS. 8 and 9 illustrate an example including super pixels and analog binning;

FIG. 10 illustrates an example embodiment of a pixel array configured according to a scrambling method having binning support; and

FIGS. 11 and 12 illustrate digital imaging systems according to example embodiments.

### DETAILED DESCRIPTION

Example embodiments will now be described more fully with reference to the accompanying drawings. Many alternate forms may be embodied and example embodiments should not be construed as limited to example embodiments set forth herein. In the drawings, the thicknesses of layers and regions may be exaggerated for clarity, and like reference numerals refer to like elements.

It will be understood that, although the ter first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural for as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data (e.g., image data) represented as physical, electronic quantities within the computer system's registers and memories into other data similarly represented as physical quantities within the computer system memories or registers or other such information storage, transmission or display devices.

Example embodiments relate to pixel arrays, image sensors, image sensing systems, digital imaging systems and methods of operating the same. Example embodiments will be described herein with reference to complementary metal oxide semiconductor (CMOS) image sensors (CIS). However, those skilled in the art will appreciate that example embodiments may be applicable to other types of image sensors.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “storage medium,” “computer readable medium,” and/or “computer readable storage medium,” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable storage medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

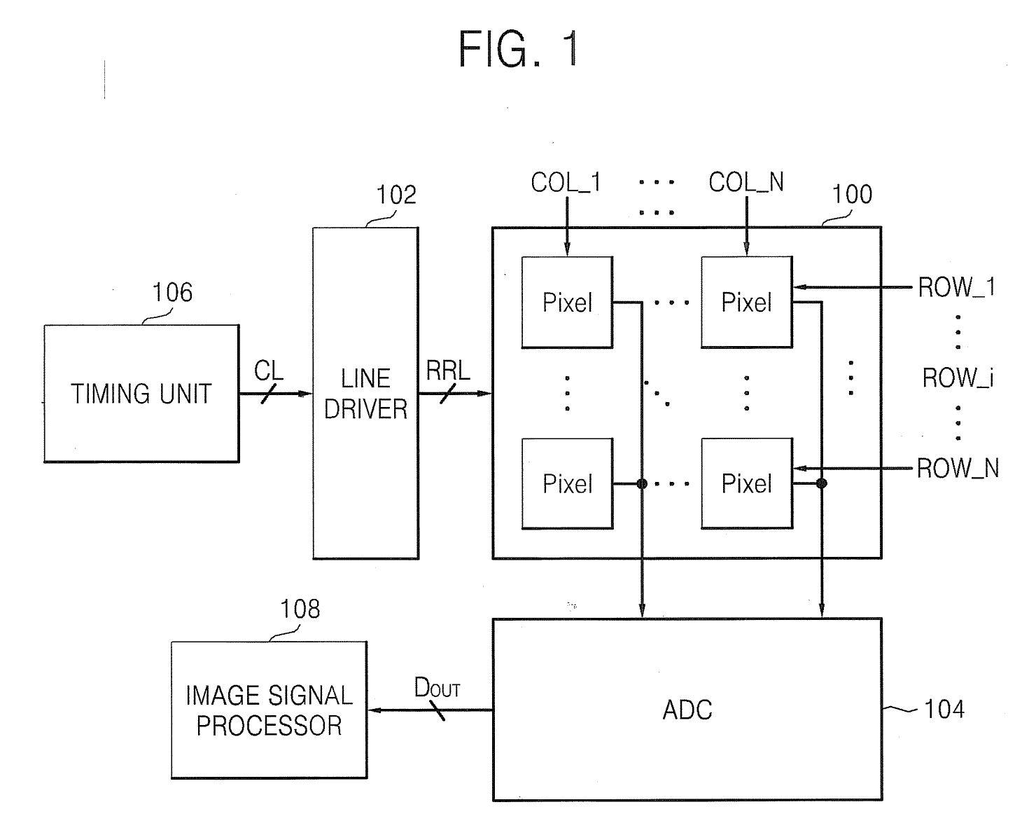

FIG. 1 illustrates a conventional complementary-metal-oxide-semiconductor (CMOS) image sensor.

Referring to FIG. 1, a timing unit or circuit 106 controls a line driver 102 through one or more control lines CL. In one example, the timing unit 106 causes the line driver 102 to generate a plurality of read and reset pulses. The line driver 102 outputs the plurality of read and reset pulses to a pixel array 100 over a plurality of select lines RRL.

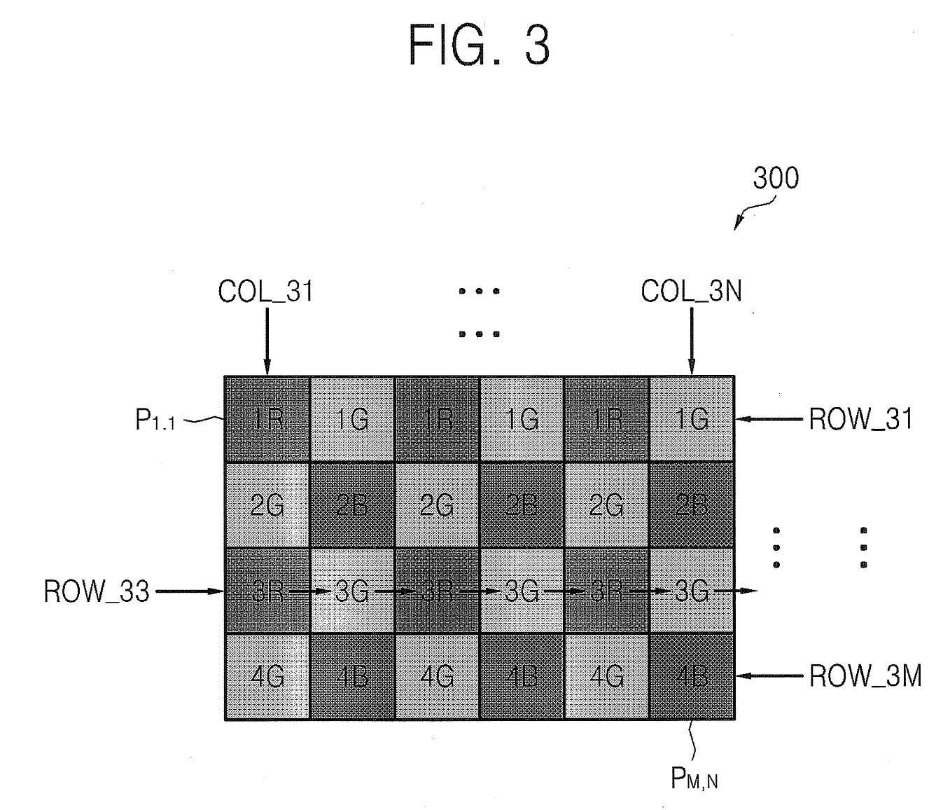

The pixel array 100 includes a plurality of pixels arranged in an array of rows ROW_1 through ROW_M and columns COL_1 through COL_N. As described in more detail with regard to FIG. 3, each of the plurality of select lines RRL corresponds to a row of pixels in the pixel array 100. In FIG. 1, each pixel may be an active-pixel sensor (APS), and the pixel array 100 may be an APS array.

In more detail with reference to example operation of the image sensor in FIG. 1, read and reset pulses for an i-th row ROW_i (where i={1, . . . , N}) of the pixel array 100 are output from the line driver 102 to the pixel array 100 via an i-th one of the select lines RRL. In one example, the line driver 102 applies a reset signal to the i-th row ROW_i of the pixel array 100 to begin an exposure period. After a given, desired or predetermined exposure time, the line driver 102 applies a read signal to the same i-th row ROW_i of the pixel array 100 to end the exposure period. The application of the read signal also initiates reading out of pixel information (e.g., exposure data) from the pixels in the i-th row ROW_i. The conventional manner in which pixel information is read out will be discussed in more detail later with regard to FIG. 3.

The analog-to-digital converter (ADC) 104 converts the output voltages from the readout pixels into a digital signal (or digital data). The ADC 104 may perform this conversion either serially or in parallel. An ADC 104 having a column parallel-architecture converts the output voltages into a digital signal in parallel. The ADC 104 then outputs the digital data (or digital code) D_{OUT} to a next stage processor such as an image signal processor (ISP) 108, which processes the digital data Dour to generate an image. In one example, the ISP 108 may also perform image processing operations on the digital data including, for example, gamma correction, auto white balancing, application of a color correction matrix (CCM), and handling chromatic aberrations.

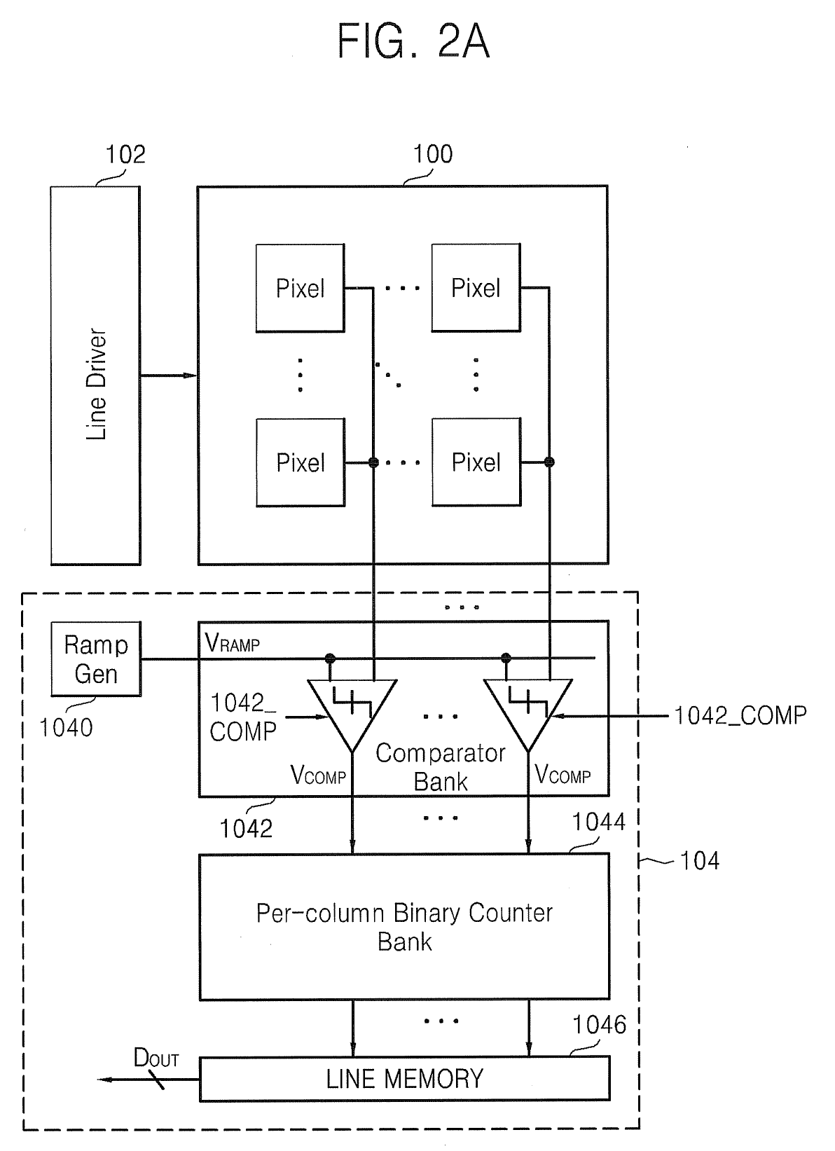

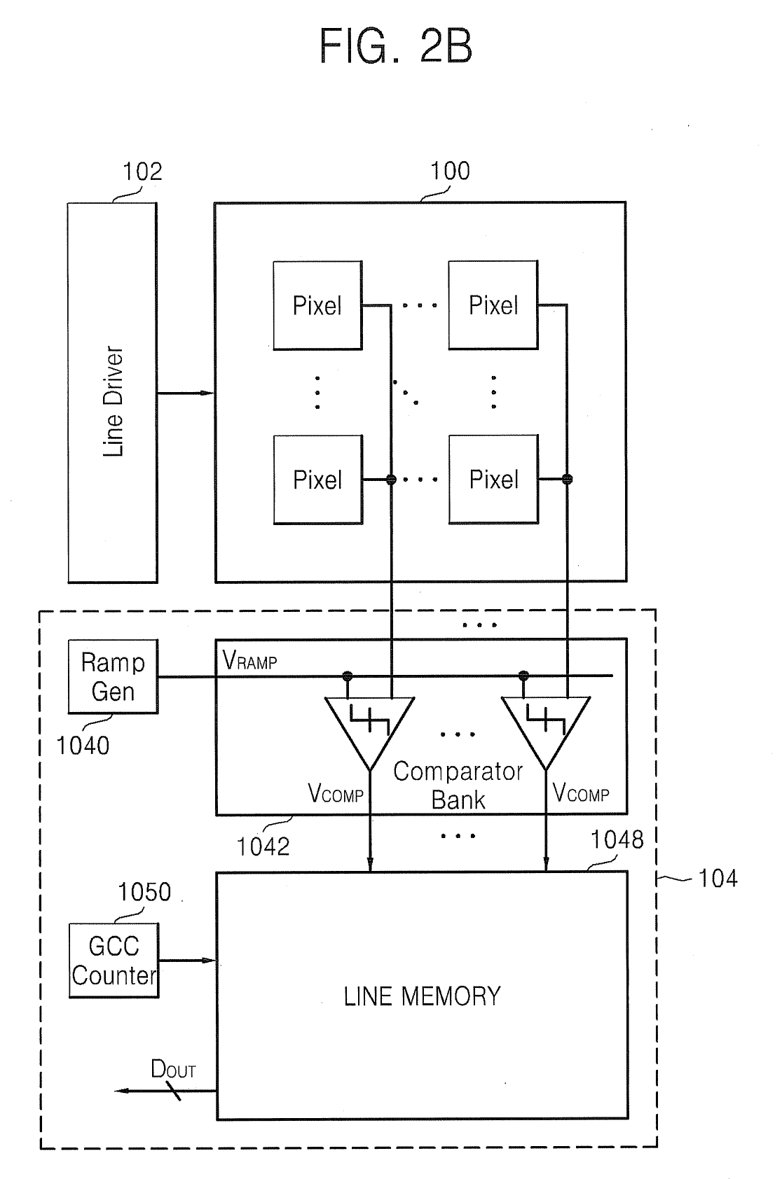

FIGS. 2A and 2B show more detailed example illustrations of the ADC shown in FIG. 1.

Referring to FIG. 2A, a ramp generator 1040 generates a ramp signal VRAMP and outputs the generated ramp signal VRAMP to the comparator bank 1042. The comparator bank 1042 compares the ramp signal VRAMP with each output from the pixel array 100 to generate a plurality of comparison signals VCOMP.

In more detail, the comparator bank 1042 includes a plurality of comparators 1042_COMP. Each of the plurality of comparators 1042_COMP corresponds to one of columns COL_1-COL of pixels P in the pixel array 100. In example operation, each comparator 1042_COMP generates a comparison signal VCOMP by comparing the output of a corresponding pixel to the ramp signal VRAMP. The toggling time of the output of each comparator 1042_COMP is correlated to the pixel output voltage.

The comparator bank 1042 outputs the comparison signals VCOMP to a counter bank 1044, which converts the comparison signals VCOMP into digital output signals.

In more detail, the counter bank 1044 includes a counter corresponding to each column COL_1-COL_N of the pixel array 100, and each counter converts a corresponding comparison signal VCOMP into a digital output signal. The counter bank 1044 outputs the digital output signals to a line memory 1046.

The line memory 1046 stores the digital data from the counter bank 1044 while a next set of output pixel voltages are converted into digital output signals.

Referring to FIG. 2B, in this example the comparator 1042 outputs the comparison signals VCOMP to the line memory 1048 as opposed to the binary counter bank 1044 shown in FIG. 2A. Otherwise, the ramp generator 1040 and the comparator bank 1042 are the same as described above with regard to FIG. 2A.

A Gray code counter (GCC) 1050 is coupled to the line memory 1048. In this example, the GCC 1050 generates a sequentially changing Gray code.

The line memory 1048 stores the sequentially changing Gray code from the GCC 1050 at a certain time point based on the comparison signals VCOMP received from the comparator bank 1042. The stored Gray code represents the intensity of light received at the pixel or pixels.

As discussed above, line noise observed in conventional pixel arrays results from common noise that is added to all pixels with the same timing. Changing the timing of different pixels alters this noise pattern. As discussed herein, a timing line refers to a set of pixels having the same timing signals. In one example, the set of pixels are coupled to the same select line. Further, a physical line of pixels is referred to herein as a physical line. In conventional image sensors, the timing line coincides with or is completely included in the physical line (e.g., row).

FIG. 3 illustrates a portion of a pixel array configured according to a conventional readout method.

Referring to FIG. 3, the pixel array 300 includes M rows ROW_31 through ROW_3M and N columns COL_31 through COL_3N of pixels P_{1,1}-P_{M,N}. For example purposes, the pixel array 300 is shown as a red-green-blue (RGB) array and each pixel P_{1,1}-P_{M,N} is a red (R), green (G) or blue (B) pixel.

In FIG. 3, each pixel P_{1,1}-P_{M,N} is designated by a timing line and color. In this case, each timing line coincides with a horizontal physical line (or physical row of pixels). For example, pixel P_{1,1} is part of the first timing line and is color red. Thus, pixel P_{1,1} is designated as 1R. Similarly, pixel P_{3,N} is part of the third timing line and is color green. Thus, pixel P_{3,N} is designated 3G. Somewhat more generally, a red pixel in first timing line is designated 1R, a blue pixel in the second timing line is designated 2B, and so on. In FIG. 3, each timing line coincides with a single corresponding physical line. For example, the third timing line includes pixel sequence {3R, 3G, 3R, 3G, 3R, 3G} all of which are located in the third physical line ROW_33.

Because the third timing line {3R, 3G, 3R, 3G, 3R, 3G} and the third physical line ROW_33 coincide with one another, the entire third physical line ROW_33 is read out in response to a readout signal pulse using a conventional readout method. Thus, in response to a readout signal, all readout pixels are from the same physical line.

Contrary to the conventional example shown in FIG. 3, in pixel arrays according to example embodiments, pixels in each physical line are distributed among several timing lines to suppress generation of regular noise patterns. Said another way, each timing line includes pixels from several physical lines, rather than a single physical line. The noise becomes more unstructured (“white”) by randomizing (or pseudo-randomizing) the distribution of a physical line of pixels among several timing lines. According to example embodiments, randomizing or scrambling may be performed at the physical level of the pixel array either statically or dynamically. And, descrambling may be performed in the digital domain.

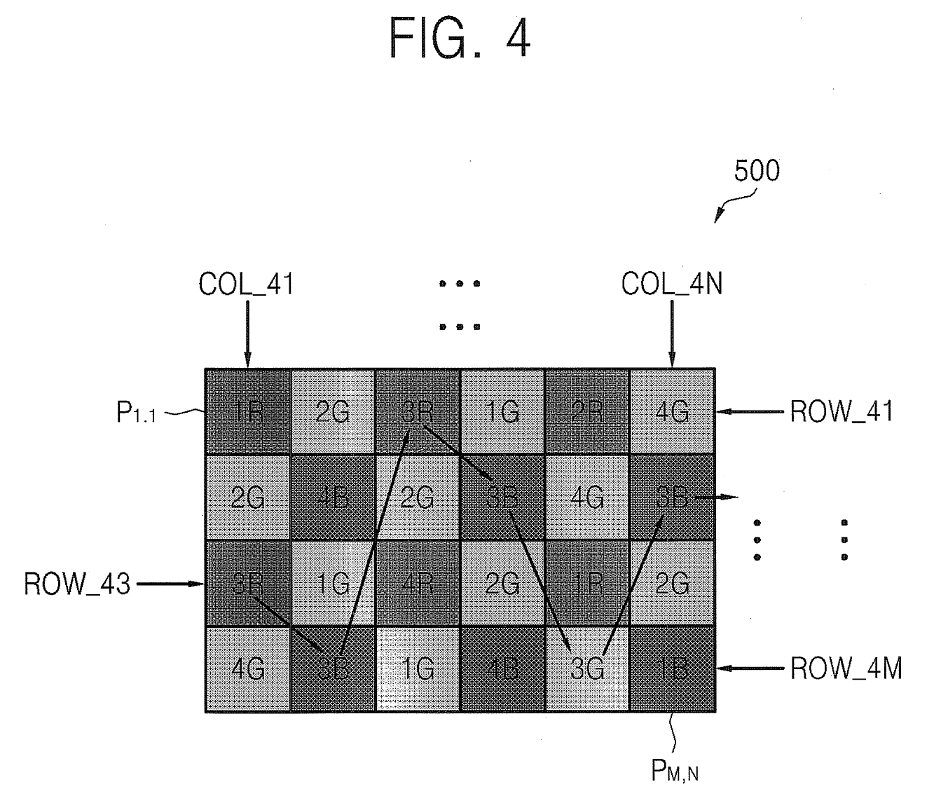

FIG. 4 illustrates a pixel array 500 configured to be read out according to an example embodiment.

Referring to FIG. 4, the pixel array 500 includes M rows ROW_41 through ROW_4M and N columns COL_41 through COL_4N of pixels P_{1,1}-P_{M,N}. In the example embodiment shown in FIG. 4, the pixel array 500 is shown as a red-green-blue (RGB) array, and each pixel P_{1,1}-P_{M,N} is a red (R), green (G) or blue (B) pixel. However, example embodiments may be implemented in conjunction with other color filters (e.g., red, green, blue, cyan (RGBE); cyan, yellow, yellow, magenta (CYYM); cyan, yellow, green, magenta (CYGM); etc.). As discussed above with regard to FIG. 3, in FIG. 4 each pixel P_{1,1}-P_{M,N} is designated by a timing line and color.

According to this example embodiment, each timing line includes pixels from several physical lines of the pixel array 500. The pixels P_{1,1}-P_{M,N} of the pixel array 500 are configured to be read out according to a random pattern. Moreover, in being readout, non-adjacent pixels are read out concurrently in response to the same readout signal. At least a portion of the non-adjacent pixels are from a plurality of non-adjacent physical lines (e.g., columns or rows) of pixels of the pixel array 500.

For example, as shown in FIG. 4, the third timing line (denoted by arrows) includes pixel sequence (3R, 3B, 3R, 3B, 3G, 3B), but all of pixels in the third timing line do not coincide with the third physical line ROW 43. Rather, the third timing line includes pixels from a plurality of physical lines (e.g., each of Rows ROW_41-ROW4M) of the pixel array 500. Example methods for distributing pixels from a physical line among several timing lines will be discussed in more detail below.

According to at least one example embodiment, the timing lines may be scrambled by fully random reordering or distributing pixels of the physical lines among several timing lines such that the timing lines are randomized.

In an alternative example embodiment, blocks of pixels within the pixel array are individually scrambled according to a random sub-pattern. This is referred to as block-based scrambling. In this example, each physical line of pixels is distributed among several timing lines within each block of pixels.

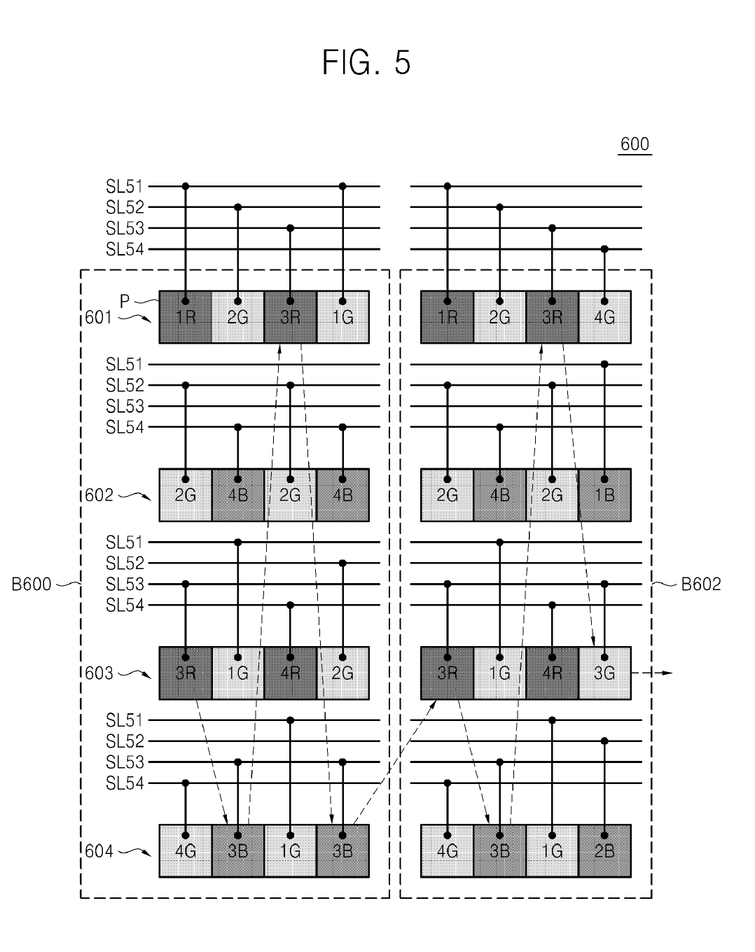

FIG. 5 illustrates an example embodiment of a portion of a pixel array 600 configured according to an unconstrained block-based scrambling method.

In the example embodiment shown in FIG. 5, pixels P from each physical line are distributed among several timing lines. For example, the third timing line (denoted by arrows in FIG. 5) includes pixel sequence {3R, 3B, 3R, 3B, 3R, 3B, 3R, 3G}, but all of these pixels do not coincide with the third physical line 603. Rather, the third timing line includes pixels from a plurality of physical lines; for example, the first physical line 601, the third physical line 603 and the fourth physical line 604.

The pixels P in the pixel array 600 shown in FIG. 5 are grouped (or divided) into blocks of (Bᵣ×B_{c}) pixels, wherein Bᵣ is 4 and B_{c} is 4. In this example, the pixel array 600 shown in FIG. 5 is divided into two blocks B600 and B602, wherein each block is 4×4 pixels in size.

Each of blocks B600 and B602 is scrambled according to one of K random sub-patterns. The blocks of pixels are scrambled by connecting the pixels P in each block to a random sequence of select lines SL51-SL54. For example, the pixels in physical line 601 of block B600 are respectively connected to select lines SL51, SL52, SL53, SL51 from left to right. The pixels P in physical line 602 of block B600, however, are respectively connected to select lines SL52, SL54, SL52, SL54 from left to right.

By connecting the pixels P in each block to a random sequence of select lines, each timing line includes a random sequence of pixels from several physical lines and each block of pixels is scrambled (or randomized) according to one of K random sub-patterns.

The set of K random sub-patterns and what pattern is used for each block B may be prepared (e.g., off-line and/or in advance) using a random number generator such as a shuffle random generator or the like. As is known, a shuffle random generator generates a random or pseudo-random sequence of numbers. As is also known, a shuffle random generator may include a linear feedback shift register (LFSR), a counter and a table. The LFSR may act as a pseudo-random number generator (PRNG). Moreover, any other known methods or devices for generating a random or pseudo-random sequence of number may also be used.

Still referring to FIG. 5, by scrambling each of blocks B600 and B602 according to one of K random sub-patterns, the pixel array 600 is scrambled according to a random pattern.

The unconstrained block-based scrambling method shown in FIG. 5 reduces the number of lines required for decoding. And, the set of K random sub-patterns may be relatively low depending on block size. In one practical implementation, K may be about 16. In this example, the total memory L needed for descrambling the scrambling pattern when pixels are readout is given by Equation (1) shown below.

$$L = [ \frac{TotalRow \times TotalColumns}{{B}_{r} \times {B}_{c}} \times {log}_{2} K ] \qquad ( 1 )$$

Because the distance between two adjacent timing pixels is bounded by the height of a block of lines plus one pixel, the overall length of control signals is also bounded. When the number of pixel lines is large enough (e.g., about 8 or more) the scrambling of residual line noise improves the perceived noise level.

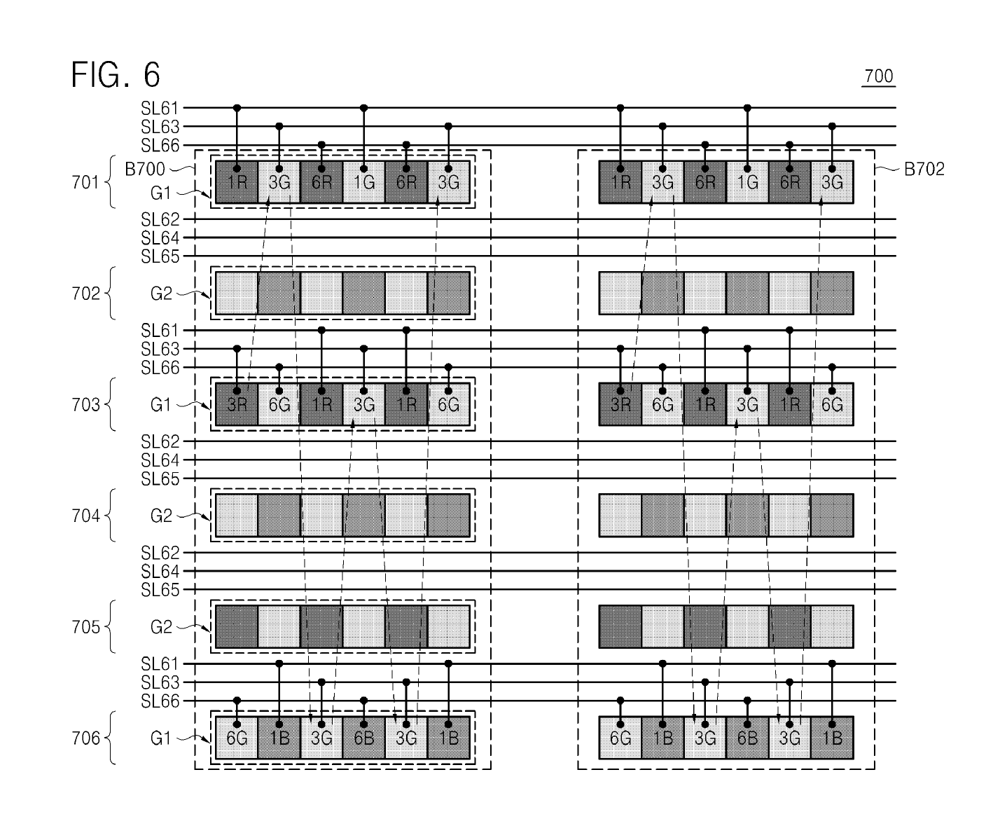

FIG. 6 illustrates a portion of a pixel array 700 configured according to a constrained block-based scrambling method. Similar to the example embodiments shown in FIGS. 4 and 5, in the example embodiment shown in FIG. 6 the pixels from each physical line are distributed among several timing lines. For example, the third timing line (denoted by arrows in FIG. 6) includes pixel sequence {3R, 3G, 3G, 3G, 3G, 3G, 3R, 3G, 3G, 3G, 3G, 3G}, but these pixels do not coincide with the third physical line 703. Rather, the pixels of the third physical line 703 (as well as the other physical lines) are distributed among several timing lines. Said another way, each timing line includes pixels from several different physical lines.

The example embodiment shown in FIG. 6 is similar to the example embodiment shown in FIG. 5 in that the pixels of the pixel array 700 are divided into blocks of (Bᵣ×B_{c}) pixels. Unlike the example embodiment shown in FIG. 5, however, in FIG. 6, Bᵣ is 6 and B_{c} is 6.

Moreover, in the example embodiment shown in FIG. 6, each block of pixels is further grouped (or divided) into a plurality of smaller groups of pixels, and the scrambling of the pixels is performed within the smaller groups of pixels. The pixels in each group are scrambled by connecting the pixels to a random sequence of a subset of select lines, which correspond to that particular group. Accordingly, each timing line includes a random sequence of pixels from a plurality of physical lines, and each group of pixels is scrambled according to one of S random sub-patterns.

In the example shown in FIG. 6, a first group G1 includes the pixels in block B700, which are respectively connected to select lines SL61, SL63, SL66. A second group G2 includes the pixels of block B700, which are respectively connected to select lines SL62, SL64, SL65. The actual connection of pixels in the second group G2 is not shown for clarity of illustration, but pixels in the second group G2 may actually be connected using a different pattern than the pixels in the first group G1. Accordingly, the pixels in each group of each block are scrambled according to one of S random sub-patterns. Each group is scrambled in a similar or substantially similar manner according to one of S random sub-patterns. Moreover, each of the groups of pixels may be scrambled according to a different one of S random sub-patterns.

As discussed above with regard to the K random sub-patterns, the set of S random sub-patterns and what pattern is used for each block may be prepared (e.g., off-line and/or in advance) using a random number generator such as a shuffle random generator.

By scrambling each group of pixels as discussed above with regard to FIG. 6, each block of pixels is scrambled according to at least two of the S random sub-patterns. Thus, each block of pixels is configured to be read out according to at least two random sub-patterns. Each random sub-pattern corresponds to a scrambling group in which the pixels in a particular group are connected to a random selection of select lines SL61-SL66.

Moreover, the pixel array 700 is scrambled according to a random pattern, which includes multiple random sub-patterns. Thus, the pixel array 700 is configured to be read out according to a random pattern.

With regard to FIG. 6, because the number of timing lines is relatively small, several select lines may be provided for each physical line instead of connecting pixels in a single physical line to a single select line. As a result, a given pixel is connected to only one select line corresponding to its timing line.

In the example embodiment shown in FIG. 6, the electrical current is about 1/|G| lower than in the conventional architecture because each select line is connected to only 1/|G| of pixels in the physical line, which reduces voltage drop. In this example embodiment, |G| designates the number of groups in each block. In the example embodiment shown in FIG. 6, |G| is 2.

According to at least some example embodiments, the number of random sub-patterns may be increased if the select line configuration is fixed along the physical lines.

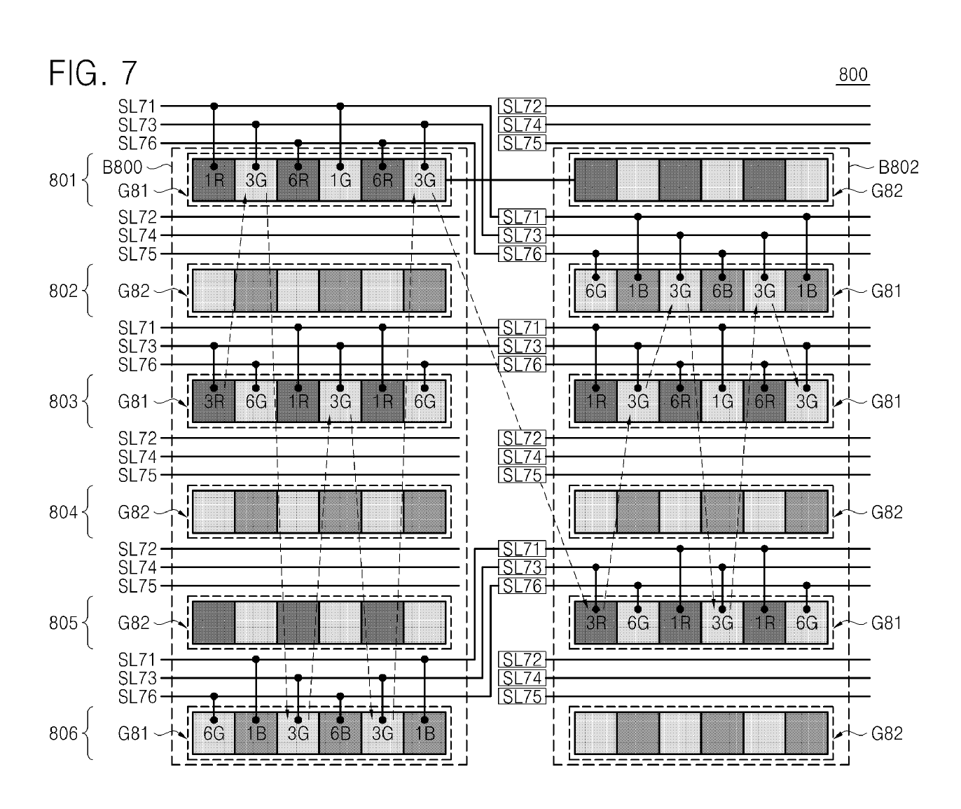

FIG. 7 illustrates an example embodiment of a portion of a pixel array 800. The pixel array 800 shown in FIG. 7 is configured according to a semi-constrained block-based scrambling method.

Similar to the example embodiment shown in FIG. 6, in FIG. 7 pixels from each physical line are distributed among several timing lines. For example, the third timing line (denoted by arrows) includes pixel sequence {3R, 3G, 3G, 3G, 3G, 3G, 3R, 3G, 3G, 3G, 3G, 3G}, but all of these pixels do not coincide with the third physical line 803. Rather, each physical line of pixels is distributed among several timing lines. Said another way, each timing line includes pixels from several different physical lines.

In the example shown in FIG. 7, a first group G81 includes the pixels of block B800, which are respectively connected to select lines SL71, SL73, SL76. A second group G82 includes the pixels of block B800, which are respectively connected to select lines SL72, SL74, SL75. The actual connection of pixels in the second group G82 is not shown for clarity of illustration, but the pixels in the second group G82 may actually be connected using a different pattern than the pixels in the first group G81. Accordingly, the pixels in each group of block B800 are scrambled according to one of S random sub-patterns.

The pixels in block B802 of FIG. 7 are grouped in a manner similar to block B800 in FIG. 7, except that the groups of pixels differ. The pixels in each group of block B802 are, however, also scrambled according to one of S random subpatterns.

In more detail, the first group G81 in block B802 includes pixels from the second, third and fifth physical lines 802, 803 and 805, whereas the first group G81 in block B800 includes pixels from the first, third and sixth physical lines 801, 803 and 806. Similarly, the second group G82 in block B802 includes pixels from the first, fourth and sixth physical lines 801, 804 and 806, whereas the second group G82 in block B800 includes pixels from the second, fourth and fifth physical lines 802, 804 and 805.

According to the example embodiment shown in FIG. 7, each of the groups may be scrambled according to a different one of S random sub-patterns.

The configuration shown in FIG. 7 is similar to the constrained block-based scrambling approach discussed above, except that the scrambling groups (e.g., G81, G82, etc.) change at each block boundary.

In the example embodiment shown in FIG. 7, each group of pixels is scrambled according to a random sub-pattern such that each block of pixels is scrambled according to a plurality of random sub-patterns. It also follows that the pixel array 800 is scrambled according to a random pattern, which includes a plurality of random sub-patterns.

Also with regard to the example embodiment shown in FIG. 7, the number of lines in each group/set may be reduced as the randomness increases. Additionally, the number of random sub-patterns may also be reduced because each pattern may be used for each block.

The example embodiment shown in FIG. 7 may increase the requisite length of the select lines relative to, for example, the example embodiment shown in FIG. 6. This length depends on the number of scrambling group changes, which depends on the width B_{c} (in pixels) of the blocks. In addition, the effect of line extension is expected to be relatively low because the load on the line is still about 1/|G|.

An alternative to, or alternative implementation of, block-based scrambling uses a linear feedback shift register (LFSR) method of randomization. In one example embodiment, several independent LFSRs are used to handle frame, block and group randomization. One or more block LFSRs may be used to randomize scrambling within blocks (e.g., B600 and B602; B700 and B702; B800 and B802) of Bᵣ lines of pixels. Group LFSRs provide randomization within the scrambling groups (e.g., G1 and G2; G81 and G82). In one example, a separate LFSR may be used for each scrambling group.

As is known, an LFSR is a pseudo-random number generator. So, an LFSR (or similar mechanism) may be used where randomization is necessary. An LFSR may be implemented in hardware and/or software.

Because LFSRs are generally known, a detailed discussion will be omitted. Example embodiments may utilize LFSRs to suppress and/or eliminate the need to store patterns and/or pattern mappings because each time an LFSR is initiated to a particular starting value, the LFSR generates the same sequence. LFSRs may also increase randomization, thereby increasing the value of, for example, K in Equation (1).

In a more specific example, an LFSRs configuration and initial conditions may be defined by a designer as desired, and used as random number generators during design of a pixel array (e.g., 500, 600, 700, 800) of an image sensor to determine the scrambling pattern for the pixel array.

As described in more detail below, use of an LFSR enables a descrambling block/unit to generate the scrambling pattern for each frame based on (using) the knowledge of LFSRs and the initial conditions defined during design. Once the scrambling pattern for the frame is known, the descrambling unit may reverse (descramble) the scrambling pattern on-the-fly. Accordingly, example embodiments need not use memory to store random patterns and pattern maps, thereby increasing efficiency.

A frame LFSR provides frame level randomization. The randomization is initialized at the start of each frame of image data to maintain a fixed pattern of randomization such that the random pattern reflects the physical structure of connections between pixels and the timing lines. The frame LFSR generates one value per Bᵣ lines of pixels. This generated value is used to initialize the block LFSRs and the group LFSRs.

In one example, a block LFSR is used to select the scrambling pattern for each block of Bᵣ×B_{c} pixels from a set (sometimes referred to as a “dictionary”) of block patterns. In this case, a block LFSR output is used to select one of K block patterns in the dictionary. For example, if K is 16, then the 4 least significant bits of the block LFSR output may be used to select one of the K block patterns. In at least this example embodiment, the same or a substantially similar procedure with the same initial conditions may be applied during layout of the sensor array. The block patterns may be prepared in advance (e.g., off-line and/or predetermined) and stored. Alternatively, the block LFSR may be used as a pseudo-random number generator to generate scrambling patterns on-the-fly. Because the frame LFSR is reset to given, desired or predefined initial conditions at the start of each frame and the block LFSR is initialized by the frame LFSR, the scrambling patterns generated for each physical block of pixels remain constant and correspond to the actual scrambling pattern of physical connection between select lines and pixels.

According to at least some example embodiments, the group LFSR output is used to select lines for group partitioning. Group partitioning may be carried out according to the above-described constrained or semi-constrained scrambling methods. Again, because the frame LFSR is reset at the start of each frame and each group LFSR is initialized by the frame LFSR, the group partitioning generated for each physical block of pixels remains constant and corresponds to the actual scrambling pattern of physical connection between select lines and pixels.

As mentioned above, by using LFSRs, actual mapping between pixels and timing lines may be generated on-the-fly and need not be stored in a memory. Accordingly, memory requirements may be reduced (e.g., significantly reduced).

According to at least some example embodiments, the total number of timing lines of the image sensor may be a multiple of the number of lines (e.g., rows) Bᵣ in each block in order to simplify descrambling. If the number of physical lines of the image sensor is not a multiple of the number of lines Bᵣ in each block, dummy lines may be used to make the number of lines a multiple of Bᵣ.

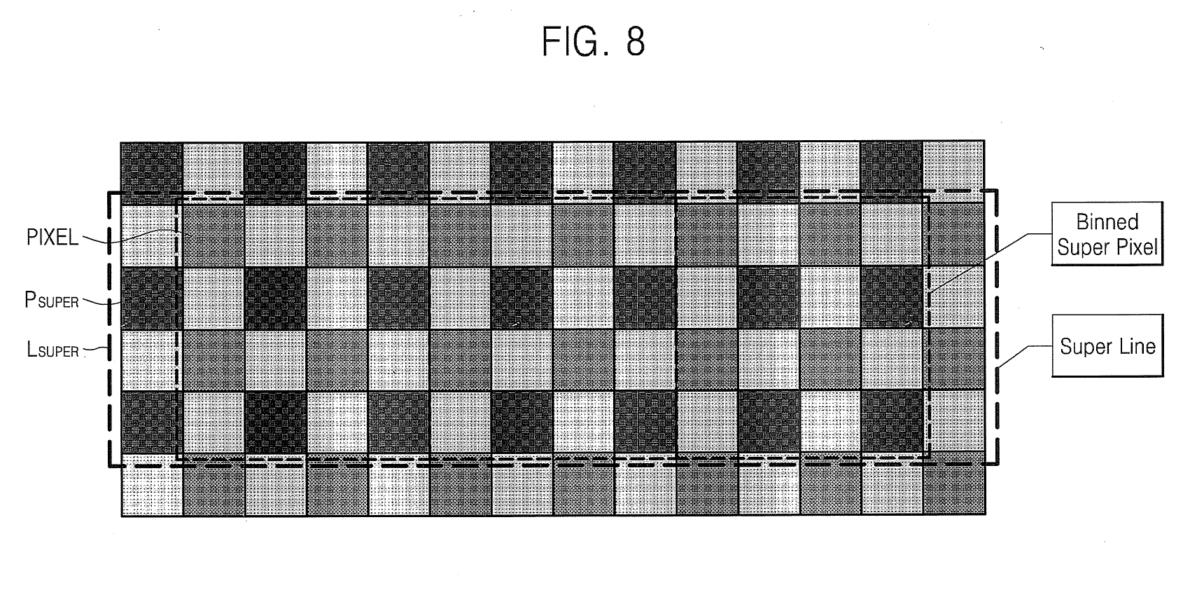

FIG. 8 illustrates an example embodiment utilizing super pixels and binning.

In order to support analog binning, additional constraints may be added. For example, the concept of super pixels and an additional level of randomization within the super pixel may be defined. In this case, pixels belonging to the same binning group may be synchronized.

Without binning, the readout and descrambling is similar or substantially similar to that discussed above, but also takes into account the additional level of randomization within a super pixel.

When binning is applied, all pixels of the same color belonging to the same super pixel are combined in the analog domain before/during readout so the additional level of randomization is not applicable.

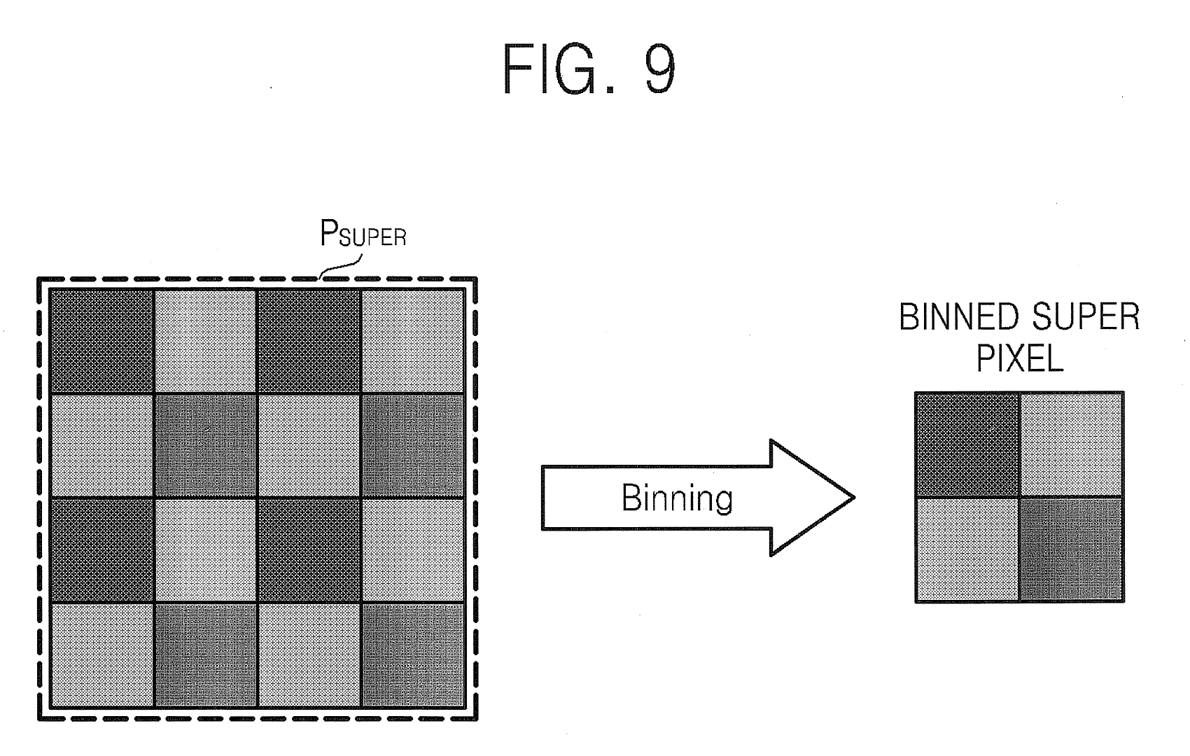

Analog binning refers to combining of pixels in the analog domain to provide lower resolution output. FIG. 8, for example, illustrates a portion of a pixel array of an image sensor with binning capabilities of up to 2× in each direction. In the binning mode, a super pixel includes all pixels combined by binning from the four colors R, Gr, Gb and B. A super line is a line of super pixels. An example output of a super pixel with analog binning applied is shown in FIG. 9.

Binning is sometimes referred to as analog averaging. An alternative way to reduce resolution in the analog domain is pixel subsampling (also referred to as skipping), where the information in part of the pixels is discarded. But, subsampling generally reduces image quality.

According to at least one example embodiment, any of the scrambling methodologies presented above may be applied to super pixels/super lines in the same or substantially the same manner as discussed above. Additional scrambling may be introduced to pixels within each super pixel.

In an example embodiment with binning support, binned super pixels are scrambled according to any of the previously described methods. The individual pixels within each binned super pixel may be considered as a block (e.g., of Bᵣ×B_{c} pixels), and any of the above-described methods may be applied to randomize the block of pixels according to a random pattern(s) or subpattern(s). In one example, the semi-constrained block based scrambling method may be applied to each binned super pixel.

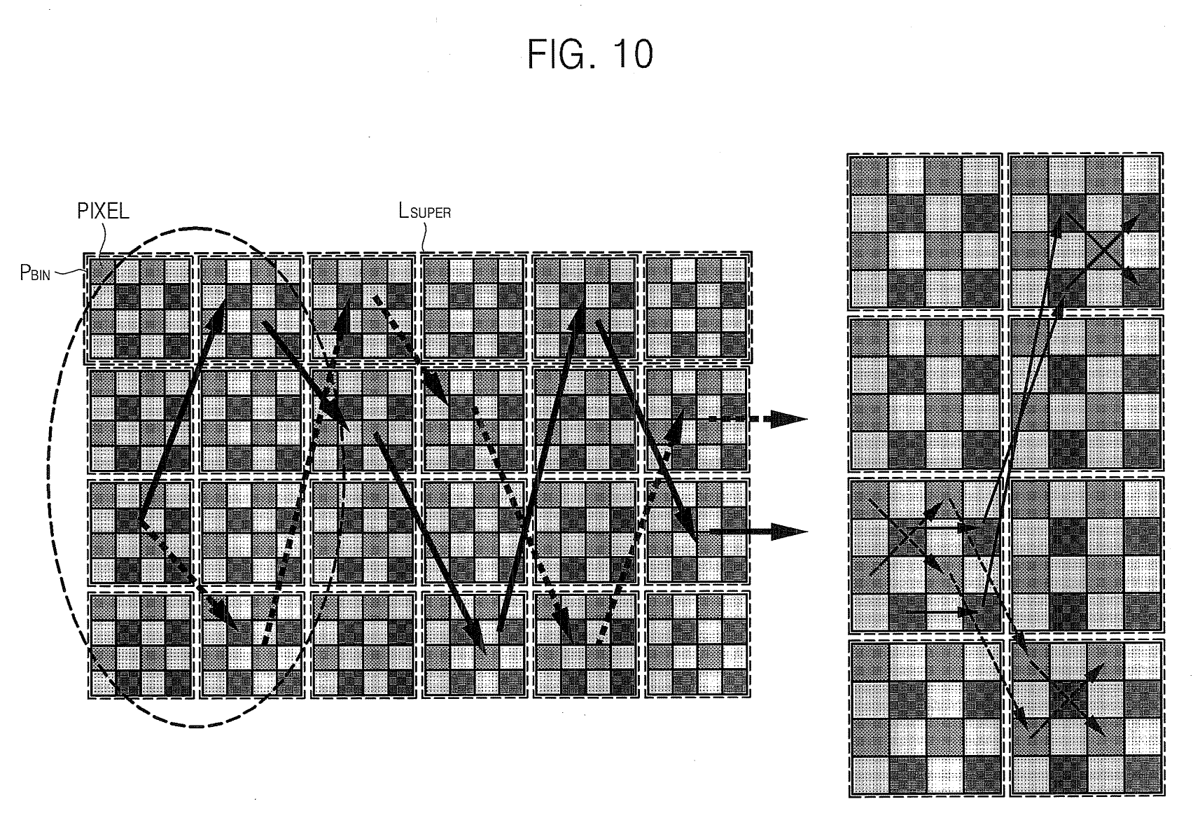

FIG. 10 illustrates an example embodiment in which scrambling with binning support is applied.

Referring to FIG. 10, the plurality of super lines L_{SUPER} are sub-divided into a plurality of binned super pixels P_{BIN}. Each of the plurality of binned super pixels P_{BIN} includes a plurality of adjacent pixels PIXEL, and each of the plurality of binned super pixels P_{BIN} are configured to be read out according to a random sub-pattern.

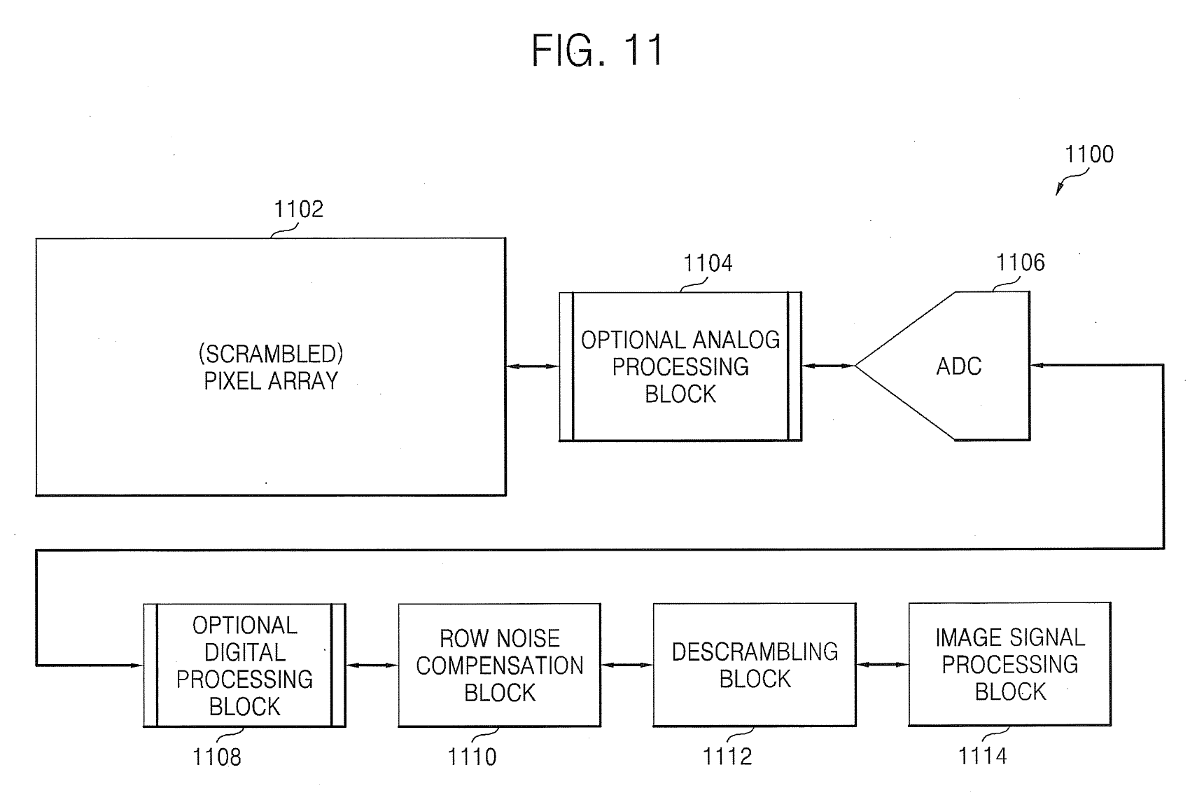

FIG. 11 illustrates a block flow diagram of a digital imaging system according to an example embodiment.

Referring to FIG. 11, the digital imaging system 1100 includes a pixel array 1102, an optional analog processing block/unit 1104, an analog to digital converter (ADC) 1106, an optional digital processing block/unit 1108, a row noise compensation block/unit 1110, a descrambling block/unit 1112 and an image signal processing block/unit 1114.

In some cases, all analog signal processing is performed within the ADC 1106. In other cases, analog processing need not be performed. On the other hand, in some designs substantial processing (e.g., including conventional row noise correction) may be performed in the analog domain. As a result, the analog processing block/unit 1104 shown in FIG. 11 is also optional based upon implementation.

Similarly, in some cases, the digital processing block/unit 1108 shown in FIG. 11 is also optional based on implementation because conventional digital processing (e.g., conventional digital row noise correction) may be performed elsewhere.

The pixel array 1102 may be a pixel array configured as described above with regard to any of FIGS. 4-10.

Still referring to FIG. 11, signals from read out pixels are input to the optional analog processing block/unit 1104, which performs conventional analog processing including (e.g., including analog gain, signal level adjustments, pedestal, etc.).

Once processed, the signals are converted into digital signals by the analog to digital converter (ADC) 1106. Alternatively, signals from the read out pixels may be output directly from the active pixel array 1102 to the ADC 1106. In this case, the analog processing block/unit 1104 may be omitted.

The digital signals are then processed by the digital processing block/unit 1108. In this example, the digital processing block/unit 1108 performs, for example, pixel reordering, global offset/pedestal correction, mismatch correction, etc. Because these operations are known, a detailed discussion is omitted. The processed digital signals are then input to the row noise compensation block/unit 1110. Alternatively, the digital signals from the read out pixels may, instead, be directly output from the ADC 1106 to the row noise compensation block/unit 1110. In this example, the digital processing block/unit 1108 may be omitted.

The row noise compensation block/unit 1110 may be any known row noise compensation block/unit 1110 configured to apply any conventional row noise correction scheme, which estimates and compensates for applicable interference components. Although shown in FIG. 11, the row noise compensation block/unit 1110 may be omitted depending on implementation.

The compensated digital signals are descrambled at the descrambling block/unit 1112. The descrambling block/unit 1112 descrambles the digital signals according to the scrambling approach implemented at the image sensor 1100.

In more detail, the pixels corresponding to the digital signals input to the descrambling block/unit 1112 are arranged by timing lines. With regard to the example embodiment shown in FIG. 6, for example, the first timing line includes {1R, 1B, 1R, 1G, 1R, 1B, 1R, 1B, 1R, 1G, 1R, 1B}. After Bᵣ lines are read out, the descrambling block/unit 1112 performs reordering so the descrambled output is {1R, 3G, 6R, 1G, 6R, 3G, 1R, 3G, 6R, 1G, 6R, 3G}, which corresponds to the first physical line 701. To do so, the descrambling block/unit 1112 includes either inverse mapping for all different block patterns or uses the same LFSR registers with the same initialization to obtain the inverse mapping. As discussed above, the descrambling block/unit 1112 uses LFSRs and the initial conditions defined during design to generate the scrambling pattern for each frame. Once the scrambling pattern for the frame is known, the descrambling block/unit 1112 reverses (descrambles) the scrambling on-the-fly. Accordingly, example embodiments need not use memory to store K block patterns and pattern maps thereby increasing efficiency. Again, because LFSRs are generally known, a detailed discussion is omitted.

In one example, the descrambling block/unit 1112 stores the inverse of all of the above-described random (sub) patterns for descrambling pixel information read out from the pixel array.

The descrambling block/unit 1112 outputs the descrambled digital signals to the image signal processing block/unit 1114. The image signal processing block/unit 1114 is configured to process the descrambled digital signals (image data) for storage in a memory (not shown) and/or display by a display unit (e.g., display unit 304 shown in FIG. 3).

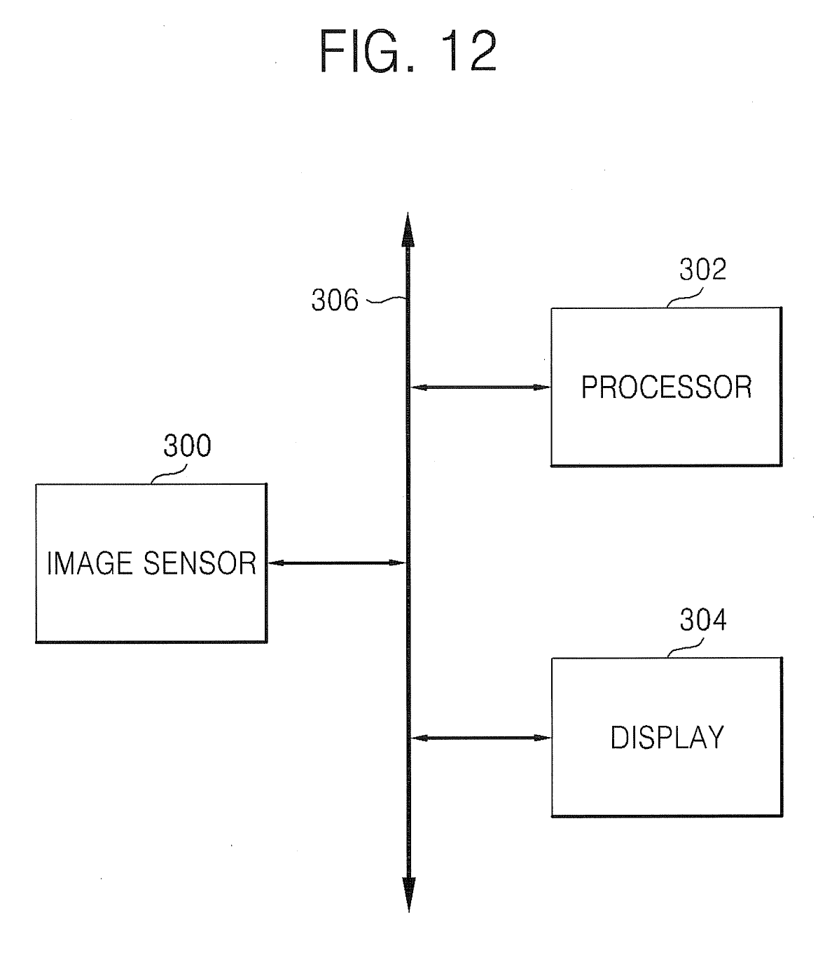

FIG. 12 is a block diagram illustrating a digital imaging system according to another example embodiment.

Referring to FIG. 12, a processor 302, an image sensor 300, and a display 304 communicate with each other via a bus 306. The processor 302 is configured to execute a program and control the digital imaging system. The image sensor 300 is configured to capture image data by converting optical images into electrical signals. The image sensor 300 may be an image sensor including, for example, the pixel array 1102, the optional analog processing block/unit 1104, the analog to digital converter (ADC) 1106, the optional digital processing block/unit 1108, the row noise compensation block/unit 1110, and the descrambling block/unit 1112 described above with regard to FIG. 11. The processor 302 may be configured to process the captured image data for storage in a memory (not shown) and/or display by the display unit 304. The digital imaging system may be connected to an external device (e.g., a personal computer or a network) through an input/output device (not shown) and may exchange data with the external device.

For example, the digital imaging system shown in FIG. 12 may embody various electronic control systems including an image sensor (e.g., a digital camera), and may be used in, for example, mobile phones, personal digital assistants (PDAs), laptop computers, netbooks, tablet computers, MP3 players, navigation devices, household appliances, or any other device utilizing an image sensor or similar device.

The foregoing description of example embodiments has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A pixel array for an image sensor, the pixel array comprising:
a plurality of pixels arranged in an array, the plurality of pixels being configured to be read out according to a random pattern such that non-adjacent pixels from a plurality of physical lines in the array are read out concurrently.

2. The pixel array of claim 1, wherein at least a portion of the non-adjacent pixels are from a plurality of non-adjacent physical lines in the array.

3. The pixel array of claim 1, wherein the plurality of pixels are divided into blocks of pixels, each block of pixels being configured to be read out according to at least a first random sub-pattern.

4. The pixel array of claim 3, wherein each block of pixels is further divided into a plurality of groups, each of the plurality of groups including randomly selected physical lines of pixels, and wherein the pixels in each group are configured to be read out according to a second random sub-pattern.

5. The pixel array of claim 3, wherein each block of pixels is configured to be read out according to at least two random sub-patterns.

6. The pixel array of claim 1, wherein pixels in the array are grouped into a plurality of super pixels, and each of the plurality of super pixels is configured to be read out according to a first random sub-pattern.

7. The pixel array of claim 6, wherein, for each super pixel, pixels of a same color are combined in the analog domain at least one of before and during read out.

8. The pixel array of claim 6, wherein each of the plurality of super pixels includes a plurality of pixels from a set of adjacent physical lines among the plurality of physical lines.

9. An image sensing system comprising:
the pixel array of claim 1; and
a descrambling unit configured to descramble pixel information read out from the pixel array.

10. The image sensing system of claim 9, further comprising:
an analog to digital converter configured to convert the pixel information into digital output information, and configured to store the digital output information.

11. The image sensing system of claim 10, further comprising:
a line noise compensation unit configured to estimate and compensate for line noise present in the digital output information.

12. The image sensing system of claim 11, further comprising:
an image signal processing unit configured to generate image information based on the compensated digital output information.

13. The image sensor of claim 9, wherein the descrambling unit is configured to descramble the pixel information according to a pattern inverse to the random pattern.

14. An image sensing system comprising:
the pixel array of claim 1;
a line driver configured to generate read out signals for reading out pixel information from the pixel array; and
a plurality of timing lines connecting the line driver to the pixel array, each of the plurality of timing lines being connected to at least two non-adjacent pixels, the at least two non-adjacent pixels being part of at least two non-adjacent physical lines in the pixel array.

15. The image sensing system of claim 14, further comprising:
an analog to digital converter configured to convert the pixel information into digital output information, and configured to store the digital output information.

16. The image sensing system of claim 15, further comprising:
a line noise compensation unit configured to compensate for line noise present in the digital output information.

17. The image sensing system of claim 16, further comprising:
an image signal processing unit configured to generate image information based on the compensated digital output information.

18. The image sensing system of claim 14, further comprising:
a descrambling unit configured to descramble the pixel information according to a pattern inverse to the random pattern.

19. A digital imaging system comprising:
a processor configured to process captured image data; and
the image sensing system of claim 9 configured to capture image data by converting optical images into electrical signals.

20. The digital imaging system of claim 19, further comprising:
an analog to digital converter configured to convert the pixel information into digital output information, and configured to store the digital output information.

21. The digital imaging system of claim 20, further comprising:
a line noise compensation unit configured to compensate for line noise present in the digital output information.

22. The digital imaging system of claim 19, wherein the descrambling unit is configured to descramble the pixel information according to a pattern inverse to the random pattern.

23. A digital imaging system comprising:
a processor configured to process captured image data; and
the image sensing system of claim 14 configured to capture image data by converting optical images into electrical signals.

24. The digital imaging system of claim 23, further comprising:
an analog to digital converter configured to convert the pixel information into digital output information, and configured to store the digital output information.

25. The digital imaging system of claim 24, further comprising:
a line noise compensation unit configured to compensate for line noise present in the digital output information.

26. The digital imaging system of claim 23, further comprising:
a descrambling unit configured to descramble the pixel information according to a pattern inverse to the random pattern.
